(19) United States
(12) Patent Application Publication
(10) Pub. No.: US 2006/0246931 A1
(43) Pub. Date: Nov. 2, 2006

(54) Master device, control method thereof, and electronic device having master device

(76) Inventor: Young-chan Kim, Yiwang-si (KR)

Correspondence Address: STANZIONE & KIM, LLP, 919 18TH STREET, N.W., SUITE 440, WASHINGTON, DC, 20006, US

(21) Appl. No.: 11/398,680

(22) Filed: Apr. 6, 2006

(30) Foreign Application Priority Data
Apr. 29, 2005 (KR) 2005-36315

(51) Int. Cl. H04B 7/00; H04Q 7/20

(52) U.S. Cl. 455/507

(57) ABSTRACT

A master device to communicate with a slave device through a predetermined protocol includes a first line and a second line to communicate with the slave device according to the predetermined protocol, and a controller to transmit a first signal corresponding to a stop condition of the predetermined protocol to the slave device through the first and second lines, to determine whether the stop condition is satisfied based on a voltage level of the first line and/or the second line, and to transmit a second signal to the slave device through the first and second lines to satisfy the stop condition if it is determined that the stop condition is not satisfied. Accordingly, the master device, a control method thereof, and an electronic device including the master device can restore errors and provide a communicable state to communicate between the master device and the slave device.

### CROSS-REFERENCE TO RELATED APPLICATIONS

This application claims the benefit under 35 U.S.C. § 119 of Korean Patent Application No. 2005-36315, filed on Apr. 29, 2005, in the Korean Intellectual Property Office, the disclosure of which is incorporated herein in its entirety by reference.

### BACKGROUND OF THE INVENTION

1. Field of the Invention

The present general inventive concept relates to a master device, a control method thereof, and an electronic device having the master device, and more particularly, to a master device which communicates with a slave device according to a predetermined protocol, a control method thereof, and an electronic device having the master device.

2. Description of the Related Art

Various methods are typically used for communication between devices according to protocols such as USB, IEEE 1394, RC 232, I2C, etc. The I2C protocol was developed for communication between integrated circuit (IC) chips through two bus lines. Recently, the I2C has been used for communication between devices, for example, between a computer and a display apparatus.

The I2C communication protocol uses a clock line (SCL) to transmit a clock pulse and a data line (SDA) to transmit a data signal, and the respective lines are pulled up to driving power through a pull up resistor. The respective lines are maintained at a high level or receive a pulse signal at a normal state.

If at least one of the respective lines is changed to a low level and maintained at the low level due to surrounding noise or a mechanical malfunction during the communication through the SCL and the SDA, data may be not transmitted properly.

If the SDA is maintained at the low level by a slave device which operates as a slave of the I2C protocol, a master device which operates as a master of the I2C protocol, may not change the SDA into the high level. Accordingly, the master device may not complete the communication with the slave device.

Similarly, if the SCL is maintained at the low level by the slave device, the master device may not correctly apply the clock pulse to the SCL.

Accordingly, it is desirable to provide a device or a method which enables communication between the master device and the slave device by restoring errors when a predetermined error occurs therebetween.

### SUMMARY OF THE INVENTION

Accordingly, an aspect of the present general inventive concept provides a master device, a control method thereof, and an electronic device having the master device which restore errors and provide a communicable state to communicate between the master device and a slave device.

Additional aspects and utilities of the present general inventive concept will be set forth in part in the description which follows and, in part, will be obvious from the description, or may be learned by practice of the present general inventive concept.

The foregoing and/or other aspects of the present general inventive concept may be achieved by providing a master device to communicate with a slave device through a predetermined protocol, the master device comprising a first line and a second line to communicate with the slave device according to the predetermined protocol, and a controller to transmit a first signal corresponding to a stop condition of the predetermined protocol to the slave device through the first and second lines, to determine whether the stop condition is satisfied based on a voltage level of the first line and/or the second line, and to transmit a second signal to the slave device through the first and second lines to satisfy the stop condition if it is determined that the stop condition is not satisfied.

The second signal which is transmitted by the controller may further satisfy a start condition of the predetermined protocol.

The predetermined protocol may comprise an I2C (inter-integrated circuit) protocol, the first line may comprise a clock line of the I2C protocol, and the second line may comprise a data line of the I2C protocol.

The controller may determine that the stop condition is not satisfied if the data line is maintained at a low level.

The second signal transmitted by the controller may comprise a predetermined number of clock pulses which are transmitted through the clock line, and a data signal which is transmitted through the data line and corresponds to the start condition and the stop condition of the I2C protocol by each clock pulse.

The predetermined number of the clock pulses may be nine or less.

The foregoing and/or other aspects of the present general inventive concept may also be achieved by providing a master device to operate as a master of an I2C (inter-integrated circuit) protocol, the master device comprising a clock line and a data line which are connected with a slave device operating as a slave of the I2C protocol, and a controller to apply a clock pulse to the clock line and initialize the slave device if the controller detects that the clock line remains at a low level for a predetermined period of time after applying the clock pulse.

The controller may apply a predetermined reset control signal to the slave device to initialize the slave device.

The controller may initialize the master device if it is detected that the clock line remains at the low level for the predetermined period of time after applying the clock pulse, and the slave device may be initialized as the master device is initialized.

The foregoing and/or other aspects of the present general inventive concept may also be achieved by providing a master device to communicate with a slave device through a predetermined protocol, the master device comprising a clock line to transmit a clock signal to the slave device, a data line to transmit and receive data to and from the slave device according to the clock signal, and a reset line to transmit an initialization signal to the slave device to initialize the slave device when a voltage level of the clock line remains at a low level for a predetermined amount of time after the clock line transmits the clock signal.

The foregoing and/or other aspects of the present general inventive concept may also be achieved by providing a master device to communicate with a slave device through a predetermined protocol, the mater device comprising first and second communication lines to transmit and receive signals to and from the slave device according to the predetermined protocol, and each having a predetermined default voltage level, and a controller to transmit a first signal through at least one of the first and second communication lines to terminate a communication with the slave device, to determine whether a voltage level of the first and second communication lines is at the default voltage level after transmitting the first signal, and to transmit a second signal through the at least one of the first and second communication lines to control the first and second communication lines to return to the default voltage level if it is determined that the first and second communication lines are not at the default voltage level.

The foregoing and/or other aspects of the present general inventive concept may also be achieved by providing a control method of a master device to communicate with a slave device through a predetermined protocol, the method comprising providing a first line and a second line to communicate with the slave device according to the predetermined protocol, transmitting a first signal corresponding to a stop condition of the predetermined protocol to the slave device through the first line and the second line, determining whether the stop condition is satisfied based on a voltage level of the first line and/or the second line, and transmitting a second signal to the slave device through the first and second lines to satisfy the stop condition if it is determined that the stop condition is not satisfied.

The second signal may further satisfy a start condition of the predetermined protocol.

The predetermined protocol may comprise an I2C protocol, the first line may comprise a clock line of the I2C protocol, and the second line may comprise a data line of the I2C protocol.

The determining whether the stop condition is satisfied based on the voltage level of the first line and/or the second line may comprise detecting whether the data line is at a high level or a low level, and determining that the stop condition is not satisfied if the data line is detected to be at the low level.

The foregoing and/or other aspects of the present general inventive concept may also be achieved by providing a control method of a master device to operate as a master of an I2C (inter-integrated circuit) protocol, comprising providing a clock line and a data line to be connected with a slave device operating as a slave of the I2C protocol, applying a clock pulse to the slave device through the clock line, determining whether the clock line is at a high level or a low level, initializing the slave device if it is determined that the clock line is at the low level.

The foregoing and/or other aspects of the present general inventive concept may also be achieved by providing a control method of a master device to communicate with a slave device through a predetermined protocol, the control method comprising transmitting a clock signal to the slave device through a clock line, communicating data between the master device and the slave device through a data line according to the transmitted clock signal, and initializing the slave device when a voltage level of the clock line remains at a low level for a predetermined amount of time after the transmitting of the clock signal.

The foregoing and/or other aspects of the present general inventive concept may also be achieved by providing a control method of a master device to communicate with a slave device through a predetermined protocol, the control method comprising initiating a communication between the master device and the slave device, transmitting a first signal to terminate the communication between the master device and the slave device, determining whether voltage levels communication lines connecting the master device and the slave device are at predetermined default voltage levels, and transmitting a second signal to control the voltage levels of the communication lines to return to the predetermined default values if it is determined that the voltage levels of the communication lines are not at the predetermined default levels.

The foregoing and/or other aspects of the present general inventive concept may also be achieved by providing an electronic device, comprising a master device to communicate with a slave device through a predetermined protocol, and a first line and a second line to communicate between the master device and the slave device according to the predetermined protocol, wherein the master device transmits a first signal corresponding to a stop condition of the predetermined protocol, to the slave device through the first and second lines, determines whether the stop condition is satisfied based on a voltage level of the first line and/or the second line, and transmits a second signal to the slave device through the first and second lines to satisfy the stop condition if it is determined that the stop condition is not satisfied.

The second signal transmitted by the master device may further satisfy a start condition of the predetermined protocol.

The predetermined protocol may comprise an I2C protocol, the first line may comprise a clock line of the I2C protocol, and the second line may comprise a data line of the I2C protocol.

The master device may communicate in a reading mode of the I2C protocol.

The master device may determine that the stop condition is not satisfied if the data line is maintained at a low level.

The second signal transmitted by the master device may comprise a predetermined number of clock pulses which are transmitted through the clock line, and a data signal which is transmitted through the data line and corresponds to the start condition and the stop condition of the I2C by each clock pulse.

The predetermined number of the clock pulses may be nine or less.

The foregoing and/or other aspects of the present general inventive concept may also be achieved by providing an electronic device, comprising a master device to operate as a master of an I2C (inter-integrated circuit) protocol, and a clock line and a data line to be connected with a slave device which operates as a slave of the I2C protocol, wherein the master device applies a clock pulse to the clock line, and initializes the slave device if the master detects that the clock line remains at a low level for a predetermined period of time after applying the clock pulse.

The master device may apply a predetermined reset control signal to the slave device to initialize the slave device.

The master device may be initialized if the master device detects that the clock line is maintained at the low level for the predetermined period of time after applying the clock pulse, and the slave device may be initialized as the master device is initialized.

The foregoing and/or other aspects of the present general inventive concept may also be achieved by providing an electronic apparatus using an I2C protocol, comprising a device connected to an external device through a first line to receive a data signal and a second line to receive a clock signal, to transmit or receive a first signal through the first line and the second line, and to transmit or receive a second signal through the first line and the second line according to a voltage level of at least one of the first line and the second line corresponding to the first signal.

The foregoing and/or other aspects of the present general inventive concept may also be achieved by providing a computer readable recording medium having executable codes to perform a control method of a master device to communicate with a slave device through a predetermined protocol, the method comprising transmitting a first signal corresponding to a stop condition of the predetermined protocol to the slave device through a first line and a second line, determining whether the stop condition is satisfied based on a voltage level of the first line and/or the second line, and transmitting a second signal to the slave device through the first and second lines to satisfy the stop condition if it is determined that the stop condition is not satisfied.

The foregoing and/or other aspects of the present general inventive concept may also be achieved by providing a computer readable recording medium having executable codes to perform a control method of a master device to communicate with a slave device through a predetermined protocol, the method comprising applying a clock pulse to a slave device through a clock line, determining whether the clock line is at a high level or a low level, initializing the slave device if it is determined that the clock line is at the low level.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a control block diagram illustrating an electronic device according to a an embodiment of the present general inventive concept;

FIG. 2 illustrates communication signals between a master device of the electronic apparatus of FIG. 1 and a slave device according to an I2C protocol;

FIG. 3 illustrates a clock signal and a data signal in a reading mode of the I2C protocol between the master device of the electronic apparatus of FIG. 1 and the slave device;

FIG. 4 illustrates a portion of clock pulses which is lost among clock pulses of the clock signal of FIG. 3;

FIG. 5 illustrates a data line which is maintained at a low level by the slave device after the portion of the clock pulses of FIG. 4 is lost;

FIG. 6 illustrates a stop signal applied to restore the data line of FIG. 5 which is maintained at the low level;

FIG. 7 is a control flow chart illustrating operations of the electronic device of FIG. 1 according to an embodiment of the present general inventive concept;

FIG. 8 is a control block diagram illustrating an electronic device according to another embodiment of the present general inventive concept; and

FIG. 9 is a control flow chart illustrating operations of the electronic device of FIG. 1 according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

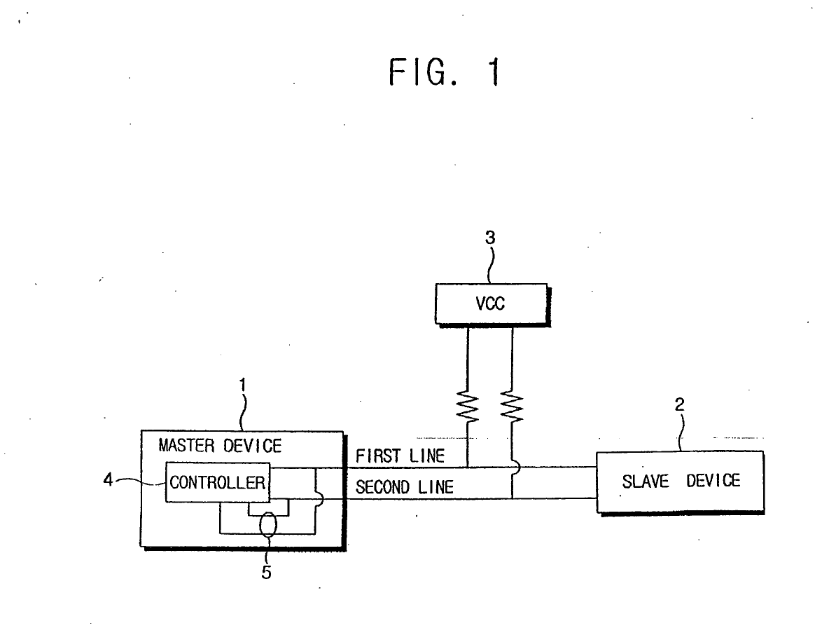

FIG. 1 illustrates an electronic device according to an embodiment of the present general inventive concept. Referring to FIG. 1, the electronic device comprises a master device 1, and a first line and a second line to allow the master device 1 to communicate with a slave device 2 according to a predetermined protocol. The first and second lines may be connected to a voltage source 3.

The master device 1 transmits a first signal corresponding to a stop condition of the predetermined protocol to the slave device 2 through the first and second lines when completing a communication with the slave device 2.

The master device 1 determines whether the stop condition is satisfied based on a voltage level of the first line and/or the second line. If the master device 1 determines that the stop condition is not satisfied, the master device 1 transmits a second signal to the slave device 2 through the first and second lines to satisfy the stop condition.

The master device 1 may comprise a controller 4 which is connected with the first and second lines to communicate with the slave device 2 and to determine whether the stop condition is satisfied based on the voltage level of the first line and/or the second line, and a feedback line 5 to connect the first line and/or the second line to a predetermined feedback port of the controller 4.

Hereinbelow, the master device 1 of the electronic device is described as using an inter-integrated circuit (I2C) protocol to communicate with the slave device 2, according to an embodiment of the present general inventive concept.

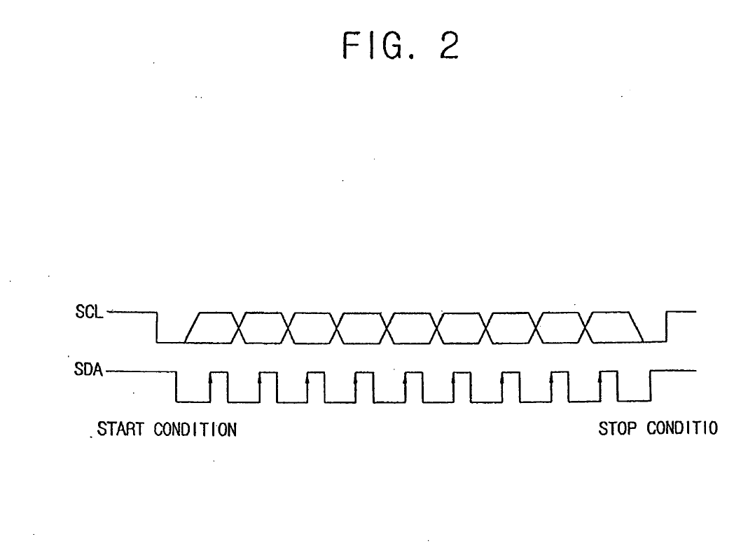

In the I2C protocol, the master device 1 operates as a master of the I2C protocol, and communicates with the slave device 2, which operates as a slave of the I2C protocol through a clock line (SCL) which transmits a clock signal and a data line (SDA) which transmits a data signal, as illustrated in FIG. 2. That is, in the I2C protocol, the first and second lines of the master device 1 are the SCL and the SDA, respectively.

A start condition is required to start the I2C communication. The controller 4 satisfies the start condition by applying a start signal which controls of a voltage level of the SDA to change from a high level to a low level in a state in which a voltage level of the SCL is maintained at a high level.

The stop condition is required to end the I2C communication. The controller 4 satisfies the stop condition by applying the first signal which controls the voltage level of the SDA to change from the low level to the high level in a state in which the voltage level of the SCL is maintained at the high level.

The I2C communication mode comprises a writing mode and a reading mode. The writing mode transmits data from the master device 1 to the slave device 2, and the reading mode transmits the data from the slave device 2 to the master device 1.

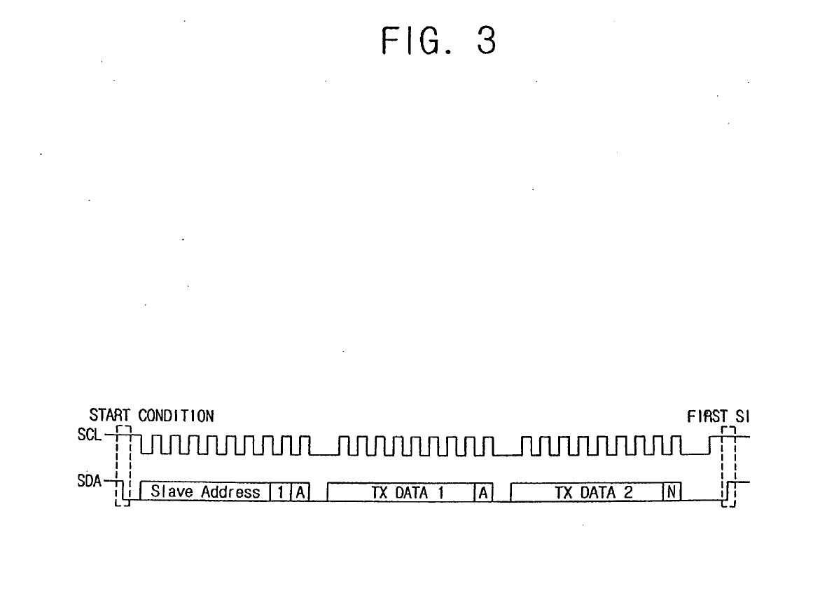

FIG. 3 illustrates signals transmitted through the SLC and SDA in the reading mode.

Referring to FIG. 3, the slave device 2 transmits the data signal to the master device 1 through the SDA according to the clock signal provided from the master device 1 through the SLC. When the data transmission from the slave device 2 is complete, the master device 1 transmits the first signal corresponding to the stop condition to the slave device 2, thereby completing the communication between the master device 1 and the slave device 2. The master device 1 can transmit the first signal through the SLC as a clock pulse of the clock signal.

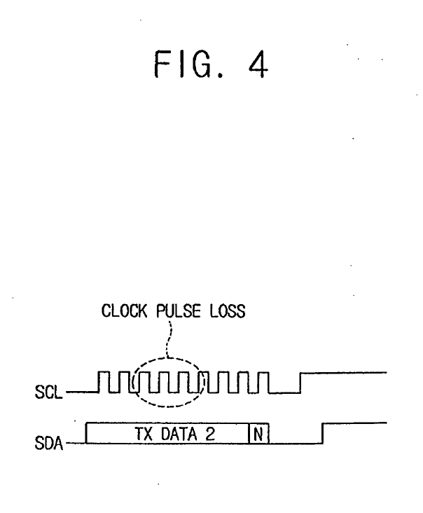

The clock signal transmitted through the SLC includes a plurality of clock pulses. If a portion of the clock pulses which are applied from the master device 1 is lost due to surrounding noise or other reasons, as illustrated in FIG. 4, the slave device 2 interprets the clock pulse to satisfy the stop condition as a clock pulse to transmit data, and transmits the data instead of completing the communication.

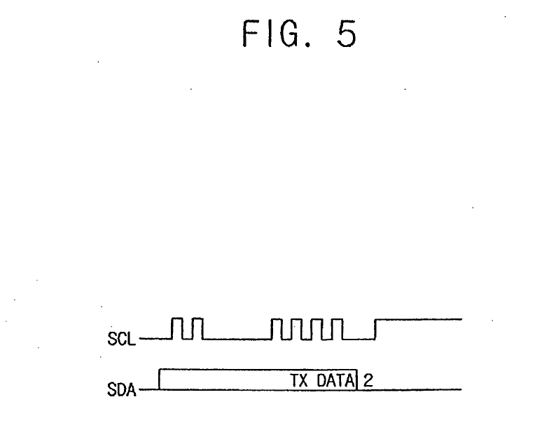

As described above, if the portion of the clock pulses is lost and the clock pulse of the first signal to satisfy the stop condition is applied, the slave device 2 transmits data remaining therein to the master device 1 instead of completing the communication according to the clock pulse of the first signal. If the transmitted data is in the low level, the voltage level of the SDA is maintained at the low level by the slave device 2, as illustrated in FIG. 5.

If the voltage level of the SDA is maintained at the low level by the slave device 2, and not changed to the high level by the master device 1 according to the first signal, the communication between the master device 1 and the slave device 2 may not be completed.

If the communication between the master device 1 and the slave device 2 is not completed, another communication cannot be performed. Accordingly, if the controller 4 determines that the stop condition is not satisfied based on the voltage level of the SDA after applying the first signal to satisfy the stop condition, the master device 1 applies the second signal to satisfy the stop condition.

The second signal may comprise a predetermined number of clock pulses which are transmitted through the clock line, and a corresponding data signal which is transmitted through the data line and corresponds to the start and stop conditions of the I2C protocol according to each clock pulse.

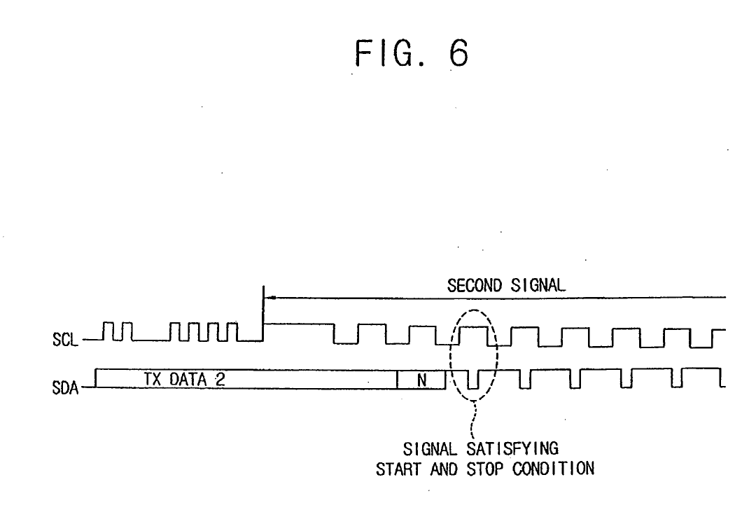

As illustrated in FIG. 6, the second signal satisfies the start and stop conditions by changing the voltage level of the SDA from the high level to the low level, and from the low level to the high level again in a state in which a single clock pulse is maintained at the high level.

The clock signal may have nine lost clock pulses at the maximum, and the predetermined number of the clock pulses included in the second signal may be set as nine.

While transmitting the second signal which includes nine clock pulses, the slave device 2 completely transmits bits of data to be transmitted and does not control the voltage level of the SDA to remain at the low level. Thus, the master device 1 and the slave device 2 may complete the communication.

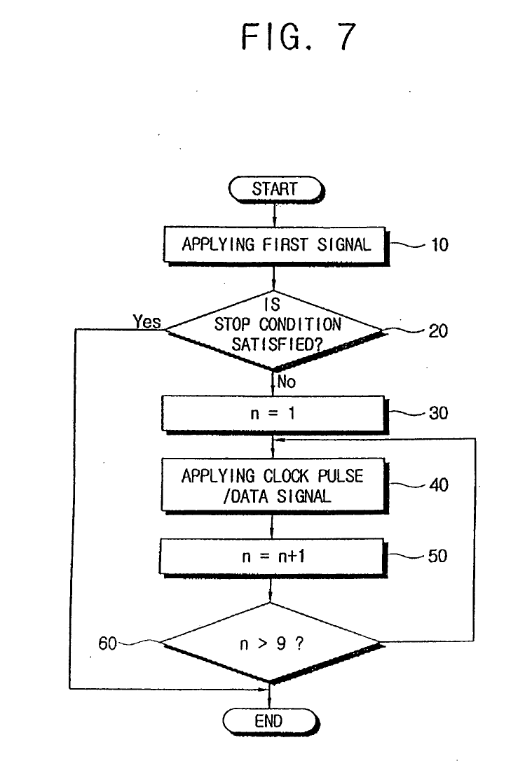

FIG. 7 is a control flow chart illustrating operations of the master device 1 according to an embodiment of the present general inventive concept.

Referring to FIG. 7, the master device 1 applies the first signal which satisfies the stop condition, to the slave device 2 to complete the I2C communication with the slave device 2 at operation 10.

The first signal controls the voltage level of the SDA to change from the low level to the high level in a state in which the voltage level of the SCL is maintained at the high level.

The master device 1 detects the voltage level of the SDA after applying the first signal and determines if the stop condition is satisfied at operation 20. If voltage level of the SDA remains at the low level after the master device 1 applies the first signal, the master device 1 determines that the stop condition is not satisfied and applies the second signal to satisfy the stop condition at operations 30, 40, 50 and 60. If the voltage level of the SDA changes from the low level to the high level in response to the first signal, the master device 1 determines that the stop condition is satisfied, and the communication between the master device 1 and the slave device 2 is complete.

The second signal comprises the clock signal having the predetermined number of clock pulse and the data signal which satisfy the start and stop conditions. As illustrated in FIG. 7, the master device starts with a first one of the clock pulses (n=1) at operation 30, and applies the first one of the clock pulses and the corresponding data signal to the slave device 2 at operation 40. The master device then sequentially moves to a next one of the clock pulses (n=n+1) at operation 50, determines whether there has already been nine clock pulses in the second signal at operation 60, and applies the next one of the clock pulses and the corresponding data signal to the slave device 2 (operation 40) when there has not already been nine clock pulses. Accordingly, the master device 1 sequentially applies the clock pulses of the second signal (operations 40 and 50) until nine clock pulses have been transmitted to the slave device 2. After nine clock pulses are transmitted to the slave device 2, the communication between the master device 1 and the slave device 2 is complete.

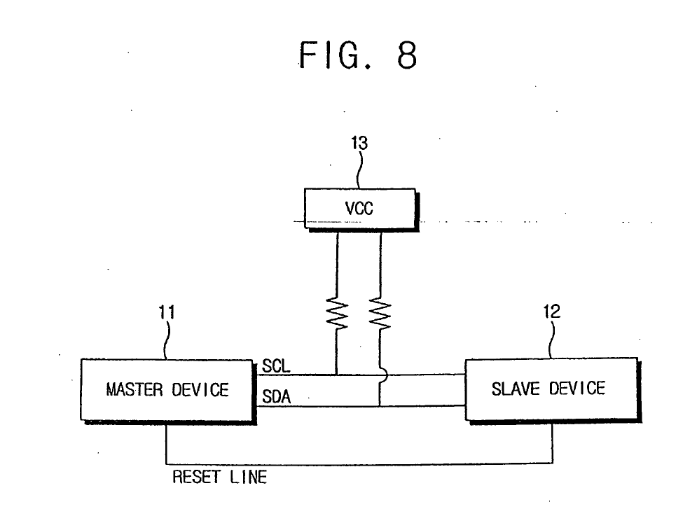

FIG. 8 illustrates an electronic device according to another embodiment of the present general inventive concept.

Referring to FIG. 8, the electronic device comprises a master device 11 to operate as a master of an I2C protocol, and a clock line (SCL) and a data line (SDA) which are connected with a slave device 12 to operate as a slave of the I2C protocol. The SCL and the SDA can be connected to a voltage source (VCC) 13.

The electronic device may also comprise a reset line to apply a reset control signal from the master device 11 to the slave device 12.

The master device 11 applies a clock pulse to send/receive data, to the slave device 12 through the SCL. If the master devise 11 detects that a voltage level of the SLC remains at a low level for a predetermined period of time after applying the clock pulse, the master device 11 determines that a mechanical malfunction of the slave device 12 is contributing to the low voltage level of the clock line, and applies the reset control signal to the slave device 12 through the reset line to initialize the slave device 12.

When the master device 11 applies the reset control command to the slave device 12, the master device 11 can apply a command to initialize itself, and the slave device 12 may be initialized corresponding thereto.

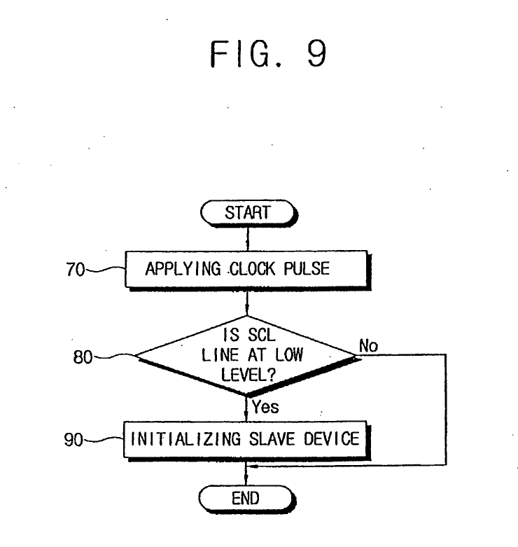

FIG. 9 is a control flow chart illustrating operations of the master device 11 operating as the master of the I2C protocol according to another embodiment of the present general inventive concept.

Referring to FIG. 9, the master device 11 applies the clock pulse to slave device 12 through the SCL at operation 70.

The master device 11 then detects whether the voltage level of the SLC remains at a low level at operation 80. If it is detected that the SCL remains at the low level at operation 80, the master device 11 applies the reset control signal to the slave device 12 to initialize the slave device 12 at operation 90.

Accordingly, the master device 11 initializes the slave device 12 and then can attempt to perform another I2C communication.

The present general inventive concept may be applied to communication between a computer and a monitor as the I2C communication between a computer and a monitor is feasible in a computer system comprising a monitor which supports DDC.

It is possible for the present general inventive concept to be realized on a computer-readable recording medium as a computer-readable code. The computer-readable recording medium includes many types of recording devices that store computer system-readable data. ROMs, RAMs, CD-ROMs, magnetic tapes, floppy discs, optical data storage, etc., are used as computer-readable recording mediums. The computer-readable recording medium can also be realized in the form of carrier waves (e.g., transmission via Internet).

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A master device to communicate with a slave device through a predetermined protocol, comprising:
a first line and a second line to communicate with the slave device according to the predetermined protocol; and
a controller to transmit a first signal corresponding to a stop condition of the predetermined protocol to the slave device through the first and second lines, to determine whether the stop condition is satisfied based on a voltage level of the first line and/or the second line, and to transmit a second signal to the slave device through the first and second lines to satisfy the stop condition if it is determined that the stop condition is not satisfied.

2. The master device according to claim 1, wherein the second signal which is transmitted by the controller further satisfies a start condition of the predetermined protocol.

3. The master device according to claim 2, wherein:
the predetermined protocol comprises an I2C (inter-integrated circuit) protocol;
the first line comprises a clock line of the I2C protocol; and
the second line comprises a data line of the I2C protocol.

4. The master device according to claim 3, wherein the controller determines that the stop condition is not satisfied if the data line is maintained at a low level.

5. The master device according to claim 3, wherein the second signal transmitted by the controller comprises:
a predetermined number of clock pulses which are transmitted through the clock line; and
a data signal which is transmitted through the data line and corresponds to the start condition and the stop condition of the I2C protocol by each clock pulse.

6. The master device according to claim 5, wherein the predetermined number of the clock pulses is nine or less.

7. A master device to operate as a master of an I2C (inter-integrated circuit) protocol, comprising:
a clock line and a data line which are connected with a slave device operating as a slave of the I2C protocol; and
a controller to apply a clock pulse to the clock line and initialize the slave device if the controller detects that the clock line remains at a low level for a predetermined period of time after applying the clock pulse.

8. The master device according to claim 7, wherein the controller applies a predetermined reset control signal to the slave device to initialize the slave device.

9. The master device according to claim 7, wherein the controller initializes the master device if it is detected that the clock line remains at the low level for the predetermined period of time after applying the clock pulse, and the slave device is initialized as the master device is initialized.

10. A master device to communicate with a slave device through a predetermined protocol, comprising:
a clock line to transmit a clock signal to the slave device;
a data line to transmit and receive data to and from the slave device according to the clock signal; and
a reset line to transmit an initialization signal to the slave device to initialize the slave device when a voltage level of the clock line remains at a low level for a predetermined amount of time after the clock line transmits the clock signal.

11. The master device according to claim 10, further comprising:
a control unit to detect the voltage level of the clock line after the clock line transmits the clock signal.

12. A master device to communicate with a slave device through a predetermined protocol, comprising:
first and second communication lines to transmit and receive signals to and from the slave device according to the predetermined protocol, and each having a predetermined default voltage level; and
a controller to transmit a first signal through at least one of the first and second communication lines to terminate a communication with the slave device, to determine whether a voltage level of the first and second communication lines is at the default voltage level after transmitting the first signal, and to transmit a second signal through the at least one of the first and second communication lines to control the first and second communication lines to return to the default voltage level if it is determined that the first and second communication lines are not at the default voltage level.

13. The master device according to claim 12, wherein the first and second communication lines comprise a clock line and a data line, respectively.

14. The master device according to claim 13, wherein the controller transmits the first and second signal through the clock line, and the second signal comprises a predetermined number of clock pulses.

15. A control method of a master device to communicate with a slave device through a predetermined protocol, comprising:
providing a first line and a second line to communicate with the slave device according to the predetermined protocol;
transmitting a first signal corresponding to a stop condition of the predetermined protocol to the slave device through the first line and the second line;
determining whether the stop condition is satisfied based on a voltage level of the first line and/or the second line; and
transmitting a second signal to the slave device through the first and second lines to satisfy the stop condition if it is determined that the stop condition is not satisfied.

16. The method according to claim 15, wherein the second signal further satisfies a start condition of the predetermined protocol.

17. The method according to claim 16, wherein the predetermined protocol comprises an I2C protocol, the first line comprises a clock line of the I2C protocol, and the second line comprises a data line of the I2C protocol.

18. The method according to claim 17, wherein the determining whether the stop condition is satisfied based on the voltage level of the first line and/or the second line comprises:
detecting whether the data line is at a high level or a low level; and
determining that the stop condition is not satisfied if the data line is detected to be at the low level.

19. A control method of a master device to operate as a master of an I2C (inter-integrated circuit) protocol, comprising:
providing a clock line and a data line to be connected with a slave device operating as a slave of the I2C protocol;
applying a clock pulse to the slave device through the clock line;
determining whether the clock line is at a high level or a low level;
initializing the slave device if it is determined that the clock line is at the low level.

20. A control method of a master device to communicate with a slave device through a predetermined protocol, comprising:
transmitting a clock signal to the slave device through a clock line;
communicating data between the master device and the slave device through a data line according to the transmitted clock signal; and
initializing the slave device when a voltage level of the clock line remains at a low level for a predetermined amount of time after the transmitting of the clock signal.

21. A control method of a master device to communicate with a slave device through a predetermined protocol comprising:
initiating a communication between the master device and the slave device;
transmitting a first signal to terminate the communication between the master device and the slave device;
determining whether voltage levels communication lines connecting the master device and the slave device are at predetermined default voltage levels; and
transmitting a second signal to control the voltage levels of the communication lines to return to the predetermined default values if it is determined that the voltage levels of the communication lines are not at the predetermined default levels.

22. An electronic device, comprising:
a master device to communicate with a slave device through a predetermined protocol; and
a first line and a second line to communicate between the master device and the slave device according to the predetermined protocol, wherein
the master device transmits a first signal corresponding to a stop condition of the predetermined protocol to the slave device through the first and second lines, determines whether the stop condition is satisfied based on a voltage level of the first line and/or the second line, and transmits a second signal to the slave device through the first and second lines to satisfy the stop condition if it is determined that the stop condition is not satisfied.

23. The electronic device according to claim 22, wherein the second signal transmitted by the master device further satisfies a start condition of the predetermined protocol.

24. The electronic device according to claim 23, wherein the predetermined protocol comprises an I2C protocol, the first line comprises a clock line of the I2C protocol, and the second line comprises a data line of the I2C protocol.

25. The electronic device according to claim 24, wherein the master device communicates in a reading mode of the I2C protocol.

26. The electronic device according to claim 25, wherein the master device determines that the stop condition is not satisfied if the data line is maintained at a low level.

27. The electronic device according to claim 25, wherein the second signal transmitted by the master device comprises:
a predetermined number of clock pulses which are transmitted through the clock line; and
a data signal which is transmitted through the data line and corresponds to the start condition and the stop condition of the I2C by each clock pulse.

28. The electronic device according to claim 27, wherein the predetermined number of the clock pulses is nine or less.

29. An electronic device, comprising:
a master device to operate as a master of an I2C (inter-integrated circuit) protocol; and
a clock line and a data line to be connected with a slave device which operates as a slave of the I2C protocol, wherein
the master device applies a clock pulse to the clock line, and initializes the slave device if the master device detects that the clock line remains at a low level for a predetermined period of time after applying the clock pulse.

30. The electronic device according to claim 29, wherein the master device applies a predetermined reset control signal to the slave device to initialize the slave device.

31. The electronic device according to claim 29, wherein the master device is initialized if the master device detects that the clock line remains at the low level for the predetermined period of time after applying the clock pulse, and the slave device is initialized as the master device is initialized.

32. An electronic apparatus using an I2C protocol, comprising:
a device connected to an external device through a first line to receive a data signal and a second line to receive a clock signal, to transmit or receive a first signal through the first line and the second line, and to transmit or receive a second signal through the first line and the second line according to a voltage level of at least one of the first line and the second line corresponding to the first signal.

33. The electronic apparatus according to claim 32, wherein:
the device is a master;
the external device is a slave; and
the master comprises a controller to transmit the first and second signals through the first and second lines.

34. The electronic apparatus according to claim 32, wherein the device is a slave, the external device is a master, and the device receives the first and second signals through the first and second lines.

35. The electronic apparatus according to claim 32, wherein the device terminates transmitting or receiving the second signal according to a second voltage level of the at least one of the first and second lines.

36. The electronic apparatus according to claim 32, wherein the device simultaneously transmits the first signal through both the first and second lines.

37. A computer readable recording medium having executable codes to perform a control method of a master device to communicate with a slave device through a predetermined protocol, the method comprising:
transmitting a first signal corresponding to a stop condition of the predetermined protocol to the slave device through a first line and a second line;
determining whether the stop condition is satisfied based on a voltage level of the first line and/or the second line; and
transmitting a second signal to the slave device through the first and second lines to satisfy the stop condition if it is determined that the stop condition is not satisfied.

38. A computer readable recording medium having executable codes to perform a control method of a master device to operate as a master of an I2C (inter-integrated circuit) protocol, the method comprising:
applying a clock pulse to a slave device through a clock line;
determining whether the clock line is at a high level or a low level;
initializing the slave device if it is determined that the clock line is at the low level.
